(19) United States
(12) Patent Application Publication
(10) Pub. No.: US 2023/0298421 A1
(43) Pub. Date: Sep. 21, 2023

(54) AUTHENTICATION CONTROL APPARATUS, AUTHENTICATION CONTROL SYSTEM, AUTHENTICATION CONTROL METHOD, AND NON-TRANSITORY COMPUTER-READABLE MEDIUM

(71) Applicant: NEC Corporation, Minato-ku, Tokyo (JP)

(72) Inventors: Honami Yuki, Tokyo (JP); Shuuji Kikuchi, Tokyo (JP); Takaya Fukumoto, Tokyo (JP); Kazuya Matsumoto, Tokyo (JP)

(73) Assignee: NEC Corporation, Minato-ku, Tokyo (JP)

(21) Appl. No.: 18/013,716

(22) PCT Filed: Jul. 1, 2020
(86) PCT No.: PCT/JP2020/025773

§ 371 Date: Dec. 29, 2022

(51) Int. Cl. G07C 9/37

(52) U.S. Cl. CPC G07C 9/37

(57) ABSTRACT

An authentication control apparatus (10) includes: a biometric information acquisition unit (11) that acquires biometric information of a pedestrian on a predetermined passage in which a plurality of light emitting elements are embedded from a captured image of the pedestrian; an authentication control unit (12) that acquires a biometric authentication result obtained using the acquired biometric information and biometric information of a plurality of persons; a position specification unit (13) that specifies a position of the pedestrian on the passage by analyzing the captured image; and a display control unit (14) that performs display control related to the biometric authentication result for the light emitting element corresponding to a light emission target region including the specified position.

### TECHNICAL FIELD

The present invention relates to an authentication control apparatus, an authentication control system, an authentication control method, and a non-transitory computer-readable medium, and more particularly to an authentication control apparatus, an authentication control system, an authentication control method, and a non-transitory computer-readable medium for controlling biometric authentication.

### BACKGROUND ART

In a facility that performs authentication at the time of entrance/exit, a gate device installed at a gate performs authentication for a person who wishes to enter or exit, and controls opening and closing of a gate according to the authentication result. In recent years, a gate-less walk-through authentication system has been demanded in order to authenticate a large number of persons simultaneously in parallel.

Patent Literature 1 discloses a technology related to a personal authentication system using a pressure sensor. When a passerby walks on a sensor sheet on which a large number of pressure sensors are arranged, the personal authentication system according to Patent Literature 1 determines whether or not the passerby is a person whose pressure information has been registered in advance based on pressure information detected by the information processing apparatus with the sensor sheet, and gives a warning in a case where the passerby is an unregistered person.

Patent Literature 2 discloses a technology related to a person authentication apparatus that determines whether or not a pedestrian walking in a predetermined area is a pre-registered person by collating a face image obtained by imaging the pedestrian with pre-registered dictionary information.

### CITATION LIST

### Patent Literature

Patent Literature 1: Japanese Unexamined Patent Application Publication No. 2016-050845

Patent Literature 2: Japanese Unexamined Patent Application Publication No. 2008-158678

### SUMMARY OF INVENTION

### Technical Problem

Here, in Patent Literatures 1 and 2, there is a problem that a notification of a biometric authentication result of an authentication target person cannot be appropriately made in a walk-through authentication system. In Patent Literature 1, since authentication of an authentication target person is performed only with pressure information detected by a pressure sensor, the authentication accuracy is lower than that of biometric authentication. In addition, in Patent Literature 2, since a door is used, the technology cannot be applied to a walk-through type.

The present disclosure has been made to solve such a problem, and an object of the present disclosure is to provide an authentication control apparatus, an authentication control system, an authentication control method, and a non-transitory computer-readable medium for appropriately making a notification of a biometric authentication result of an authentication target person in a walk-through authentication system.

### Solution to Problem

An authentication control apparatus according to a first aspect of the present disclosure includes:
biometric information acquisition means for acquiring biometric information of a pedestrian on a predetermined passage in which a plurality of light emitting elements are embedded from a captured image of the pedestrian;
authentication control means for acquiring a biometric authentication result obtained using the acquired biometric information and biometric information of a plurality of persons;
position specification unit for specifying a position of the pedestrian on the passage by analyzing the captured image; and
display control means for performing display control related to the biometric authentication result for the light emitting element corresponding to a light emission target region including the specified position.

An authentication control system according to a second aspect of the present disclosure includes:
a plurality of light emitting elements embedded in a predetermined passage;
an imaging device; and
an authentication control apparatus connected to the plurality of light emitting elements and the imaging device,
in which the authentication control apparatus includes:
biometric information acquisition means for acquiring biometric information of a pedestrian on the passage from a captured image of the pedestrian captured by the imaging device;
authentication control means for acquiring a biometric authentication result obtained using the acquired biometric information and biometric information of a plurality of persons;
position specification unit for specifying a position of the pedestrian on the passage by analyzing the captured image; and
display control means for performing display control related to the biometric authentication result for the light emitting element corresponding to a light emission target region including the specified position.

An authentication control method according to a third aspect of the present disclosure performed by a computer includes:
acquiring biometric information of a pedestrian on a predetermined passage in which a plurality of light emitting elements are embedded from a captured image of the pedestrian;
acquiring a biometric authentication result obtained using the acquired biometric information and biometric information of a plurality of persons;
specifying a position of the pedestrian on the passage by analyzing the captured image; and
performing display control related to the biometric authentication result for the light emitting element corresponding to a light emission target region including the specified position.

A non-transitory computer-readable medium storing an authentication control program according to a fourth aspect of the present disclosure causes a computer to perform:
biometric information acquisition processing of acquiring biometric information of a pedestrian on a predetermined passage in which a plurality of light emitting elements are embedded from a captured image of the pedestrian;
authentication control processing of acquiring a biometric authentication result obtained using the acquired biometric information and biometric information of a plurality of persons;
position specifying processing of specifying a position of the pedestrian on the passage by analyzing the captured image; and
display control processing of performing display control related to the biometric authentication result for the light emitting element corresponding to a light emission target region including the specified position.

### Advantageous Effects of Invention

According to the present disclosure, it is possible to provide the authentication control apparatus, the authentication control system, the authentication control method, and the non-transitory computer-readable medium for appropriately making a notification of a biometric authentication result of an authentication target person in a walk-through authentication system.

### BRIEF DESCRIPTION OF DRAWINGS

FIG. 1 is a block diagram illustrating a configuration of an authentication control apparatus according to a first example embodiment.

FIG. 2 is a flowchart illustrating a flow of an authentication control method according to the first example embodiment.

FIG. 3 is a block diagram illustrating an overall configuration of an authentication control system according to a second example embodiment.

FIG. 4 is a block diagram illustrating a configuration of an authentication apparatus according to the second example embodiment.

FIG. 5 is a flowchart illustrating a flow of face information registration processing according to the second example embodiment.

FIG. 6 is a flowchart illustrating a flow of face authentication processing performed by the authentication apparatus according to the second example embodiment.

FIG. 7 is a block diagram illustrating a configuration of an authentication control apparatus according to the second example embodiment.

FIG. 8 is a flowchart illustrating a flow of an authentication control method according to the second example embodiment.

FIG. 9 is a diagram illustrating an example of display control according to the second example embodiment.

FIG. 10 is a diagram illustrating another example of the display control according to the second example embodiment.

FIG. 11 is a flowchart illustrating a flow of passerby number monitoring processing according to the second example embodiment.

FIG. 12 is a block diagram illustrating an overall configuration of an authentication control system according to a third example embodiment.

FIG. 13 is a flowchart illustrating a flow of an authentication control method according to the third example embodiment.

FIG. 14 is a block diagram illustrating an overall configuration of an authentication control system according to a fourth example embodiment.

FIG. 15 is a block diagram illustrating a configuration of an authentication control apparatus according to a fourth example embodiment.

FIG. 16 is a flowchart illustrating a flow of an authentication control method according to the fourth example embodiment.

FIG. 17 is a flowchart illustrating a flow of body surface temperature comparison processing according to the fourth example embodiment.

FIG. 18 is a block diagram illustrating an overall configuration of an authentication control system according to a fifth example embodiment.

FIG. 19 is a block diagram illustrating a configuration of an authentication control apparatus according to the fifth example embodiment.

FIG. 20 is a block diagram illustrating a configuration of an authentication control apparatus according to a sixth example embodiment.

FIG. 21 is a flowchart illustrating a flow of an authentication control method according to the sixth example embodiment.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

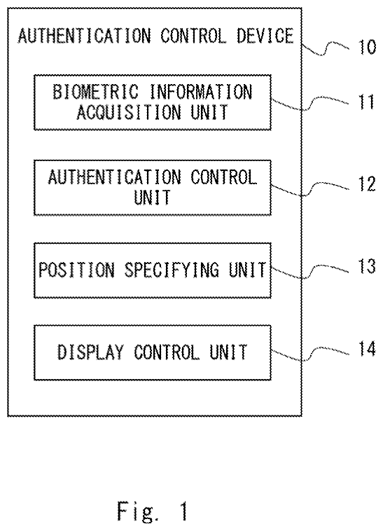

FIG. 1 is a block diagram illustrating a configuration of an authentication control apparatus 10 according to a first example embodiment. The authentication control apparatus 10 is an information processing apparatus that performs personal authentication of a person imaged by an imaging device (not illustrated) at the time of entrance to and exit from a facility or the like, and causes a light emitting element (not illustrated) embedded in a floor to display information regarding an authentication result. Here, the authentication control apparatus 10 is connected to a network (not illustrated). The network may be a wired network or a wireless network. In addition, the network is connected to the imaging device installed in a passage of the facility and the light emitting element embedded in the passage.

The authentication control apparatus 10 includes a biometric information acquisition unit 11, an authentication control unit 12, a position specification unit 13, and a display control unit 14. The biometric information acquisition unit 11 acquires biometric information of a pedestrian on a predetermined passage from a captured image of the pedestrian captured by the imaging device. Here, it is assumed that a plurality of light emitting elements are embedded in the passage. In addition, each light emitting element can control light emission from the authentication control apparatus 10. Furthermore, the biometric information is face feature information, iris information, or the like.

The authentication control unit 12 acquires a biometric authentication result obtained using the acquired biometric information and biometric information of a plurality of persons. In a case where biometric information of a plurality of persons is stored in advance in the authentication control apparatus 10, the authentication control unit 12 performs authentication processing. Alternatively, in a case where the face feature information of a plurality of persons is stored in advance in an authentication apparatus outside the authentication control apparatus 10, the authentication control unit 12 causes the authentication apparatus to perform authentication and acquires the authentication result.

The position specification unit 13 analyzes the captured image to specify a position of the pedestrian on the passage. The display control unit 14 performs display control related to the biometric authentication result for the light emitting element corresponding to a light emission target region including the specified position.

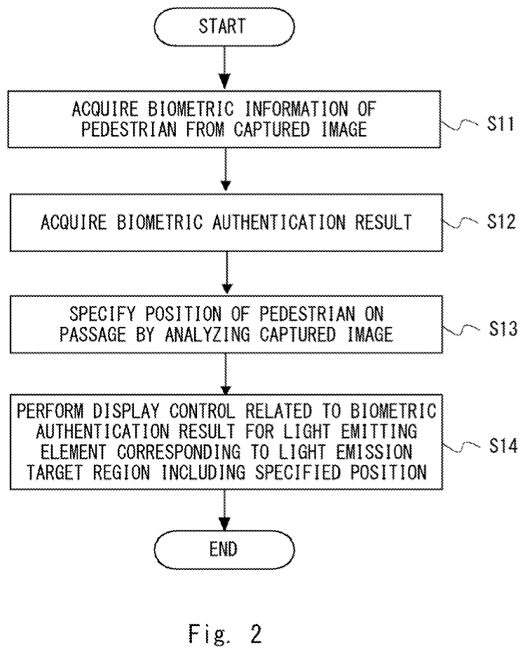

FIG. 2 is a flowchart illustrating a flow of an authentication control method according to the first example embodiment. As a premise, an image of a pedestrian on a passage is captured by the imaging device installed in the passage, and the authentication control apparatus 10 acquires the captured image. Then, the biometric information acquisition unit 11 acquires biometric information of the pedestrian from the captured image (S11).

Next, the authentication control unit 12 acquires a biometric authentication result obtained using the biometric information acquired in step S11 and biometric information of a plurality of persons (S12). Then, the position specification unit 13 analyzes the captured image to specify a position of the pedestrian on the passage (S13). Thereafter, the display control unit 14 performs display control related to the biometric authentication result acquired in step S12 for a light emitting element corresponding to a light emission target region including the position specified in step S13 (S14).

As described above, according to the present example embodiment, the biometric authentication result of the pedestrian can be displayed near the feet of the pedestrian. Therefore, it is possible to appropriately make a notification of a biometric authentication result of an authentication target person in a walk-through authentication system.

Note that the authentication control apparatus 10 includes a processor, a memory, and a storage device as components not illustrated. Furthermore, the storage device stores a computer program in which processing of an image providing method according to the present example embodiment is implemented. Then, the processor reads the computer program from the storage device into the memory, and executes the computer program. As a result, the processor implements the functions of the biometric information acquisition unit 11, the authentication control unit 12, the position specification unit 13, and the display control unit 14.

Alternatively, each of the biometric information acquisition unit 11, the authentication control unit 12, the position specification unit 13, and the display control unit 14 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the authentication control apparatus 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in a form in which each of them is connected via a communication network, such as a client server system or a cloud computing system. Furthermore, the function of the authentication control apparatus 10 may be provided in a software as a service (SaaS) format.

### Second Example Embodiment

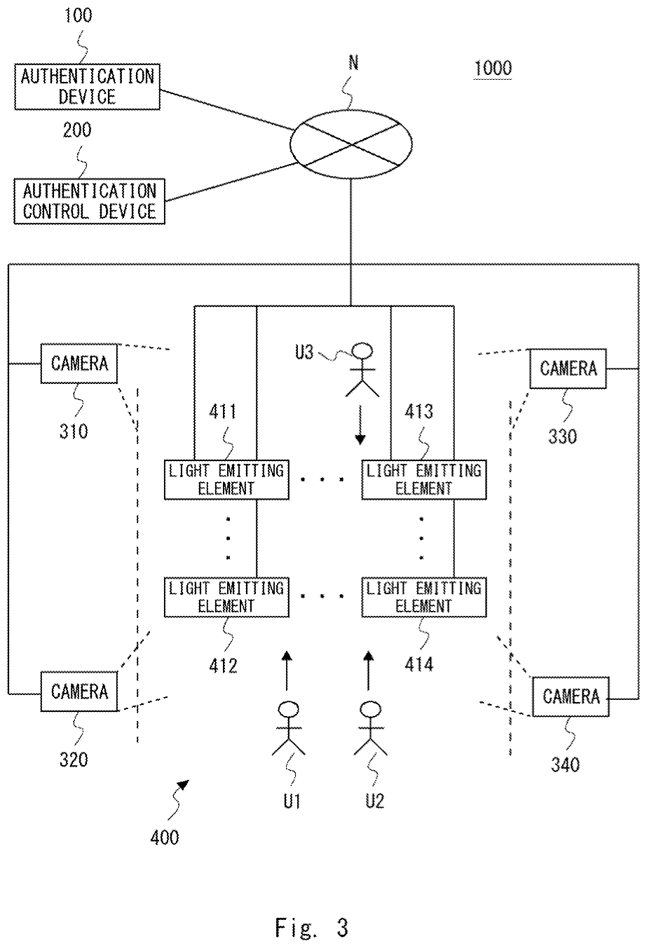

A second example embodiment is a specific example of the first example embodiment described above. FIG. 3 is a block diagram illustrating an overall configuration of an authentication control system 1000 according to the second example embodiment. The authentication control system 1000 is an information system that displays a biometric authentication result for each of a plurality of pedestrians U1 to U3 walking on a passage 400 on a light emitting element near the feet of each pedestrian. In the following description, the biometric authentication is face authentication, and the biometric information is face feature information. However, other technologies using a captured image can be applied to the biometric authentication and the biometric information.

The authentication control system 1000 includes an authentication apparatus 100, an authentication control apparatus 200, cameras 310 to 340, and light emitting elements 411 to 414. The authentication apparatus 100, the authentication control apparatus 200, the cameras 310 to 340, and the light emitting elements 411 to 414 are connected via a network N. Here, the network N is a wired or wireless communication line.

In the passage 400, four cameras 310 to 340 are installed at the gate, and a plurality of light emitting elements 411 to 414 are embedded under the floor. In particular, it is assumed that the light emitting elements 411 to 414 are arranged at predetermined intervals under the floor of a predetermined section of the passage 400 and are arranged in such a way as to substantially correspond to positions where pedestrians may be present. Each of the cameras 310 to 340 captures an image of a predetermined region of the passage 400 from each angle, and transmits the captured image to the authentication control apparatus 200 via the network N. It is sufficient if the number of cameras 310 or the like is one or more. Furthermore, the camera 310 or the like may be a stereo camera capable of measuring a distance. The light emitting elements 411 to 414 are, for example, light emitting diodes (LEDs). The number of the light emitting elements 411 and the like is two or more, but it is preferable that the light emitting elements are arranged in a grid pattern in the passage 400. The light emitting element 411 or the like receives a control signal from the authentication control apparatus 200 via the network N, and emits light in a color or a light emission pattern based on the control signal. The display control for the light emitting element 411 or the like may be performed with a plurality of adjacent light emitting elements as one unit.

The authentication apparatus 100 is an information processing apparatus that stores face feature information of a plurality of persons. In response to a face authentication request received from the outside, the authentication apparatus 100 collates a face image or face feature information included in the request with face feature information of each user, and transmits, as a response, the collation result (authentication result) to a request source.

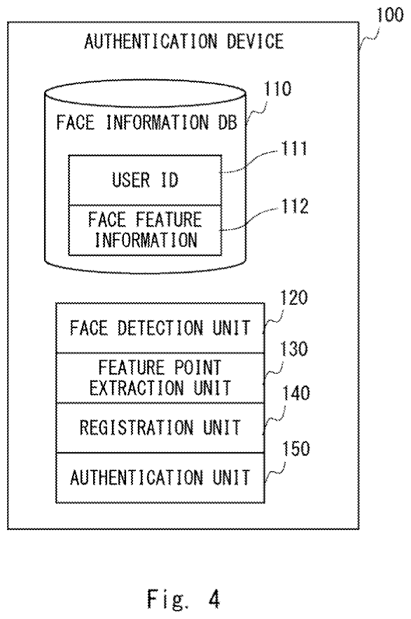

FIG. 4 is a block diagram illustrating a configuration of the authentication apparatus 100 according to the second example embodiment. The authentication apparatus 100 includes a face information database (DB) 110, a face detection unit 120, a feature point extraction unit 130, a registration unit 140, and an authentication unit 150. The face information DB 110 stores a user ID 111 and face feature information 112 of the user ID in association with each other. The face feature information 112 is a set of feature points extracted from a face image. Note that the authentication apparatus 100 may delete the face feature information 112 in the face feature DB 110 in response to a request from a user whose face feature information 112 is registered. Alternatively, the authentication apparatus 100 may delete the face feature information 112 after a lapse of a certain period from the registration of the face feature information.

The face detection unit 120 detects a face region included in a registration image for registering face information, and outputs the face region to the feature point extraction unit 130. The feature point extraction unit 130 extracts a feature point from the face region detected by the face detection unit 120, and outputs face feature information to the registration unit 140. In addition, the feature point extraction unit 130 extracts a feature point included in a face image received from the authentication control apparatus 200, and outputs face feature information to the authentication unit 150.

The registration unit 140 newly issues the user ID 111 when registering the face feature information. The registration unit 140 registers the issued user ID 111 and the face feature information 112 extracted from a registration image in association with each other in a face feature DB 110. The authentication unit 150 performs face authentication using the face feature information 112. Specifically, the authentication unit 150 collates face feature information extracted from a face image with the face feature information 112 in the face information DB 110. The authentication unit 150 transmits, as a response, whether or not the pieces of face feature information match each other to the authentication control apparatus 200. Whether or not the pieces of face feature information match each other corresponds to the success or failure of the authentication. A case where the pieces of face feature information match each other means a case where the degree of matching is equal to or higher than a predetermined value.

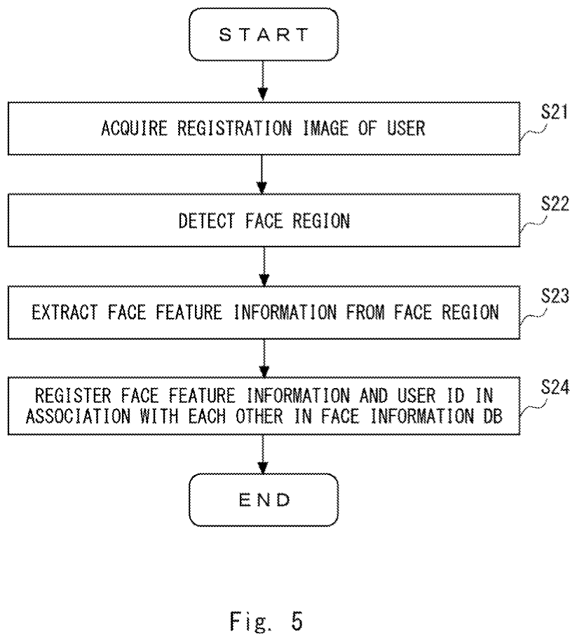

FIG. 5 is a flowchart illustrating a flow of face information registration processing according to the second example embodiment. Here, an information registration terminal (not illustrated) captures an image of a body including a face of each user, and transmits a face information registration request including the captured image (registration image) to the authentication apparatus 100 via the network N. The information registration terminal is, for example, an information processing apparatus such as a personal computer, a smartphone, or a tablet terminal.

First, the authentication apparatus 100 acquires the registration image included in the face information registration request (S21). For example, the authentication apparatus 100 receives the face information registration request from the information registration terminal via the network N. Next, the face detection unit 120 detects a face region included in the registration image (S22). Next, the feature point extraction unit 130 extracts a feature point from the face region detected in step S22 and outputs face feature information to the registration unit 140 (S23). Finally, the registration unit 140 issues the user ID 111, and registers the user ID 111 and the face feature information 112 in the face information DB 110 in association with each other (S24). The authentication apparatus 100 may receive the face feature information from the information registration terminal and register the face feature information 112 in the face information DB 110 in association with the user ID 111.

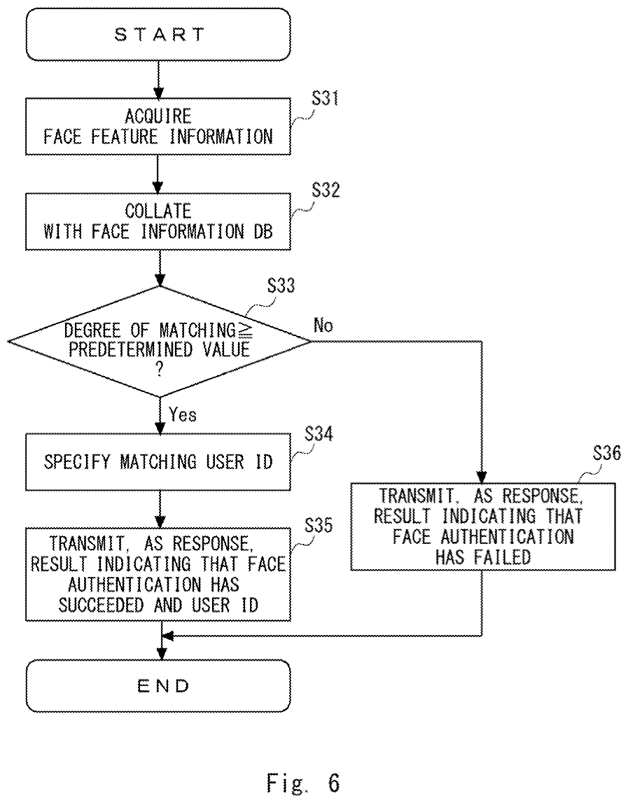

FIG. 6 is a flowchart illustrating a flow of face authentication processing performed by the authentication apparatus 100 according to the second example embodiment. First, the feature point extraction unit 130 acquires a face image for authentication included in a face authentication request (S31). For example, the authentication apparatus 100 receives the face authentication request from the authentication control apparatus 200 via the network N, and extracts face feature information from the face image included in the face authentication request as in steps S21 to S23. Alternatively, the authentication apparatus 100 may receive the face feature information from the authentication control apparatus 200. Next, the authentication unit 150 collates the acquired face feature information with the face feature information 112 in the face information DB 110 (S32). In a case where the pieces of face feature information match each other, that is, the degree of matching between the pieces of face feature information is equal to or higher than a predetermined value (Yes in S33), the authentication unit 150 specifies the user ID 111 of the user whose face feature information matches (S34), and transmits, as a response, a result indicating that face authentication has succeeded and the specified user ID 111 to the authentication control apparatus 200 (S35). In a case where there is no matching face feature information (No in S33), the authentication unit 150 transmits, as a response, a result indicating that the face authentication has failed to the authentication control apparatus 200 (S36).

In step S32, the authentication unit 150 does not need to attempt collation with all pieces of face feature information 112 in the face information DB 110. For example, the authentication unit 150 may preferentially attempt collation with face feature information registered in a period from a date of reception of the face authentication request to a date several days before the date of reception. As a result, a collation speed can be increased. In a case where the preferential collation has failed, it is sufficient if collation with all pieces of remaining face feature information is performed.

Returning to FIG. 3, the description will be continued. The authentication control apparatus 200 is an information processing apparatus that performs face authentication on the pedestrians (users) U1 to U3 included in the captured image received from the camera 310 or the like and causes the light emitting element near the feet of each pedestrian to display the face authentication result. The authentication control apparatus 200 may be redundant in a plurality of servers, and each functional block may be implemented by a plurality of computers.

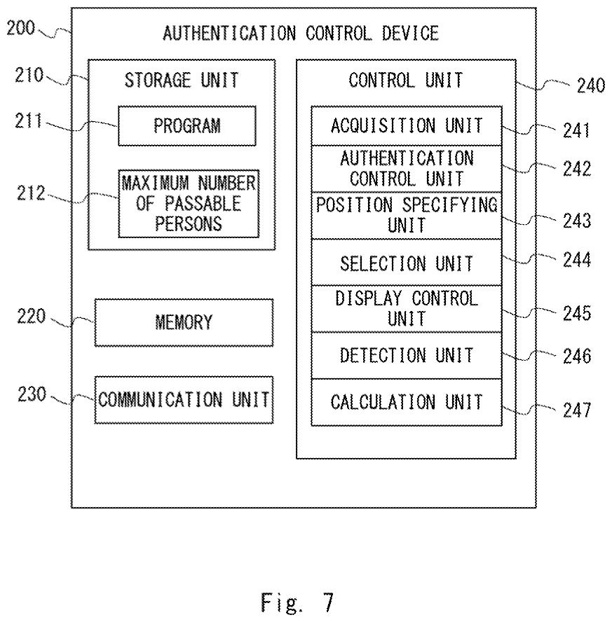

Next, the authentication control apparatus 200 will be described in detail. FIG. 7 is a block diagram illustrating a configuration of the authentication control apparatus 200 according to the second example embodiment. The authentication control apparatus 200 includes a storage unit 210, a memory 220, a communication unit 230, and a control unit 240. The storage unit 210 is a storage device such as a hard disk or a flash memory. The storage unit 210 stores a program 211 and a maximum number 212 of passable persons. The program 211 is a computer program in which the processing of an authentication control method according to the second example embodiment is implemented. The maximum number 212 of passable persons is the maximum number of pedestrians that can pass through the passage 400. The maximum number 212 of passable persons is information registered in advance by a manager or the like.

The memory 220 is a volatile storage device such as a random access memory (RAM), and is a storage region for temporarily holding information during the operation of the control unit 240. The communication unit 230 is a communication interface with the network N.

The control unit 240 is a processor that controls each component of the authentication control apparatus 200, that is, a control device. The control unit 240 reads the program 211 from the storage unit 210 into the memory 220 and executes the program 211. As a result, the control unit 240 implements the functions of an acquisition unit 241, an authentication control unit 242, a position specification unit 243, a decision unit 244, a display control unit 245, a detection unit 246, and a calculation unit 247.

The acquisition unit 241 is an example of the biometric information acquisition unit 11. The acquisition unit 241 acquires a captured image from each of the cameras 310 to 340 via the network N. Then, the acquisition unit 241 extracts (acquires) face feature information of a face region of a person from each captured image as the biometric information. In addition, the acquisition unit 241 outputs each captured image to the position specification unit 243.

The authentication control unit 242 is an example of the authentication control unit 12. The authentication control unit 242 controls face authentication for the face regions of the pedestrians U1 to U3 included in the captured image. The authentication control unit 242 causes the authentication apparatus 100 to perform face authentication using face feature information acquired from the captured image for each pedestrian, and acquires the face authentication result from the authentication apparatus 100. For example, the authentication control unit 242 transmits a face authentication request including the acquired face feature information to the authentication apparatus 100 via the network N, and receives a face authentication result of each pedestrian from the authentication apparatus 100.

The position specification unit 243 is an example of the position specification unit 13. The position specification unit 243 analyzes the captured image to specify the position of the pedestrian on the passage 400. For example, the position specification unit 243 may specify position coordinates from a region of each pedestrian in the captured image and convert the position coordinates into position coordinates on the passage 400. At least the light emitting elements 411 to 414 and the like can be specified using the specified position coordinates. In a case where each of the camera 310 and the like is a stereo camera, the position specification unit 243 specifies the position of each pedestrian on the passage 400 by analyzing two captured images.

The decision unit 244 decides a display mode and a light emission target region based on the face authentication result. That is, at least one of the display mode or the light emission target region varies depending on whether the face authentication result indicates success or failure. Here, the display mode is a manner in which the light emitting element emits light, for example, a light emission color, a light emission pattern (blinking pattern), a light emission time, and the like. In addition, the light emission target region is a peripheral region including the position of the pedestrian specified by the position specification unit 243, and one or more light emitting elements correspond to the light emission target region.

For example, in a case where the face authentication result indicates that authentication has failed, the decision unit 244 may select a wider light emission target region than that in a case where the face authentication result indicates that the authentication has succeeded. That is, in a case where the face authentication has failed, the decision unit 244 increases the region size. In a case where the face authentication result indicates that the authentication has failed, the decision unit 244 may select a light emission target region including a pedestrian traveling direction predicted from the captured image. For example, the decision unit 244 may select a region in the vicinity of the feet of the pedestrian as the light emission target region in a case where the face authentication has succeeded, and may select a wider region in the traveling direction from the feet of the pedestrian as the light emission target region in a case where the face authentication has failed. Alternatively, in a case where the face authentication has failed, the decision unit 244 may select a movement trajectory of the pedestrian as the light emission target region.

The decision unit 244 may select, as the display mode, at least one of the light emission color or the light emission pattern, the light emission color or the light emission pattern varying depending on whether the face authentication result indicates success or failure. For example, the decision unit 244 may set the light emission color to blue or green in a case where the face authentication result indicates that the authentication has succeeded, and may set the light emission color to red in a case where the face authentication result indicates that the authentication has failed. The decision unit 244 may make a blinking interval of the light emission pattern shorter in a case where the face authentication result indicates that the authentication has failed than in a case where the authentication has succeeded. This makes it easy to recognize the failure of the authentication.

In a case where the face authentication result indicates that the authentication has failed, the decision unit 244 may select the display mode in such a way that the light emission time becomes longer than that in a case where the face authentication result indicates that the authentication has succeeded. For example, green light may be emitted for a while at the feet of a pedestrian whose face authentication has succeeded, and red light may be emitted for a while at the feet of a pedestrian whose face authentication has failed. In addition, the movement trajectory of the pedestrian can be shown as the light emission time becomes longer in a case where the authentication has failed.

In addition, in a case where the face authentication result indicates that the authentication has failed, the decision unit 244 decides the display mode in such a way that the display mode is more highlighted than in a case where the face authentication result indicates that the authentication has succeeded. Here, the highlighting is made in a manner in which, for example, a luminance is increased or a blinking frequency is increased, but is not limited thereto. In addition, the highlighting may include widening the light emission target region.

The display control unit 245 is an example of the display control unit 14. The display control unit 245 performs display control according to the decided display mode for a light emitting element corresponding to the decided light emission target region. That is, the display control unit 245 specifies the light emitting element corresponding to the light emission target region, and transmits a control signal based on the display mode to the specified light emitting element via the network N.

In a case where the face authentication result indicates that the authentication has failed, the display control unit 245 performs display control in such a way as to keep lighting of the light emitting element corresponding to the light emission target region. Then, in a case where the face authentication result indicates that the authentication has succeeded after an authentication failure, the display control unit 245 performs display control in such a way as to turn off the lighting of the light emitting element kept at the time of the authentication failure.

The detection unit 246 detects the number of pedestrians in the passage 400 from the captured image. The calculation unit 247 calculates the remaining number of passable persons from the maximum number 212 of passable persons of the passage 400 and the detected number of persons. Then, the display control unit 245 performs display control in such a way as to cause a predetermined light emitting element to display the calculated number of passable persons. In addition, in a case where the detected number of persons exceeds the maximum number 212 of passable persons, the display control unit 245 performs display control in such a way as to cause a predetermined light emitting element to display a warning. Here, the predetermined light emitting element may be, for example, a specific light emitting element embedded in the vicinity of the gate of the passage 400.

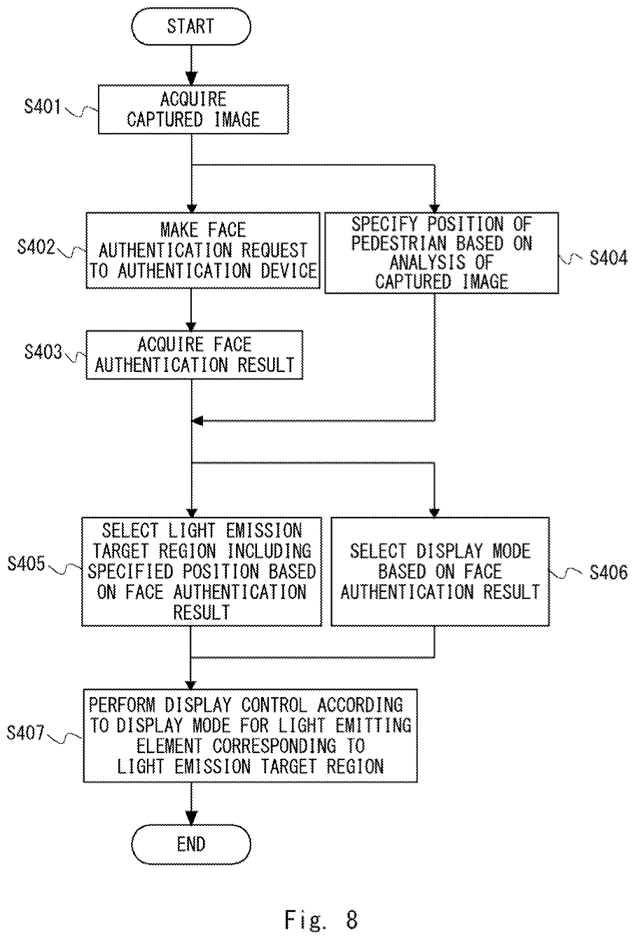

FIG. 8 is a flowchart illustrating a flow of the authentication control method according to the second example embodiment. First, as a premise, it is assumed that the pedestrians U1 to U3 are walking on the passage 400. Then, it is assumed that the cameras 310 to 340 start capturing images and sequentially transmits the captured images to the authentication control apparatus 200 via the network N.

At this time, the acquisition unit 241 acquires the captured image from each of the cameras 310 to 340 via the network N (S401). Hereinafter, processing of one image will be described. Then, the authentication control unit 242 makes a face authentication request to the authentication apparatus 100 for each pedestrian included in the captured image (S402). Specifically, the acquisition unit 241 extracts a face region of each pedestrian from the captured image, and acquires face feature information from the face region. Then, the authentication control unit 242 includes the face feature information in the face authentication request for each pedestrian and transmits the face feature information to the authentication apparatus 100 via the network N. Then, the authentication control unit 242 acquires the face authentication result for each pedestrian from the authentication apparatus 100 (S403).

In parallel with step S401, the position specification unit 243 specifies the position of the pedestrian based on analysis of the captured image (S404). That is, the position specification unit 243 converts position coordinates of the pedestrian in the captured image into position coordinates on the passage 400.

After steps S403 and S404, the decision unit 244 decides a light emission target region including the specified position based on the face authentication result (S405). In addition, the decision unit 244 decides a display mode based on the face authentication result (S406). Note that, steps S405 and S406 may be performed in parallel or in series.

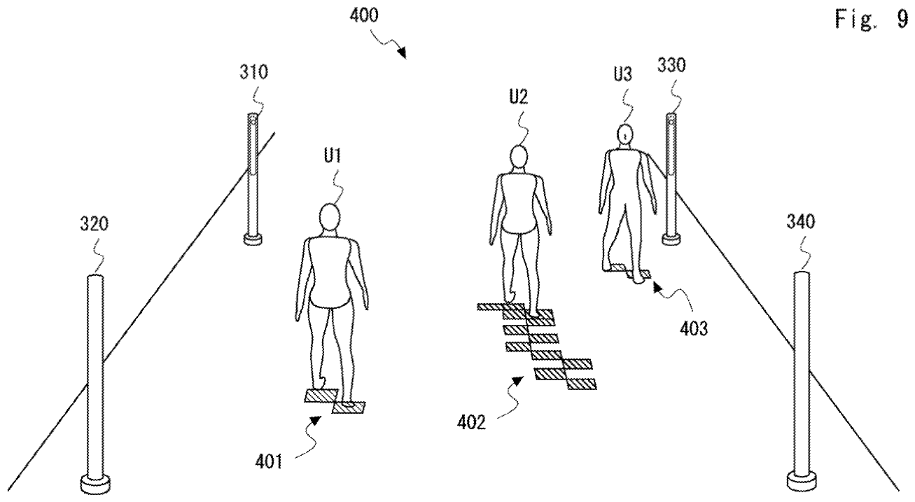

After steps S405 and S406, the display control unit 245 performs display control according to the display mode for a light emitting element corresponding to the light emission target region (S407). FIG. 9 is a diagram illustrating an example of display control according to the second example embodiment. Here, it is assumed that the pedestrians U1 and U2 travel in a depth direction of the passage 400, and the pedestrian U3 travels in a front direction. In addition, it is assumed that the pedestrians U1 and U3 have succeeded in the face authentication, and the pedestrian U2 has failed in the face authentication. Therefore, the decision unit 244 decides a wider light emission target region (display 402) for the pedestrian U2 than light emission target regions (displays 401 and 403) for the pedestrians U1 and U3. With the displays 401 and 403, regions in the vicinity of the feet of the pedestrians U1 and U3 are illuminated. In addition, the decision unit 244 may select the displays 401 and 403 that follow movements of the pedestrians U1 and U3. The display 402 may be an example in which a movement trajectory of the pedestrian U2 is illuminated. This example shows a case where the decision unit 244 decides the display modes for the pedestrians in such a way that the display mode (display 402) for the pedestrian U2 is more highlighted that the display modes (displays 401 and 403) for the pedestrians U1 and U3.

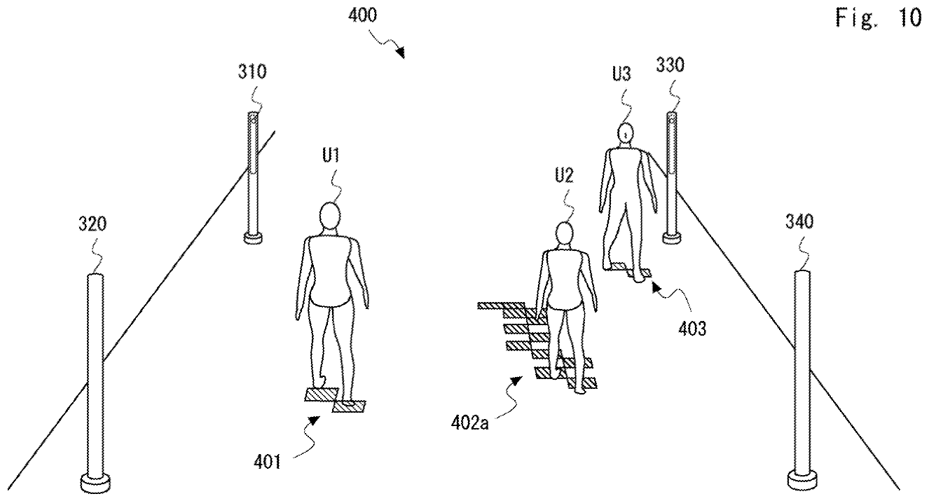

FIG. 10 is a diagram illustrating another example of the display control according to the second example embodiment. Here, a case where a traveling direction of a corresponding pedestrian is set as a light emission target region in a case where the authentication has failed is illustrated. It is assumed that the pedestrian U2 is traveling in the depth direction of the passage 400 and the face authentication has failed. At this time, the decision unit 244 analyzes captured images up to several previous frames from the latest captured image, specifies displacement of a region corresponding to the pedestrian U2, and predicts the traveling direction. Then, the decision unit 244 decides a light emission target region including the traveling direction of the pedestrian U2. Display 402a is an example in which a traveling direction side of the pedestrian U2 is the light emission target region. As a result, the pedestrian U2 can more directly recognize that the pedestrian U2 has failed in the face authentication, and can facilitate the face authentication, for example, by turning his/her face toward the camera.

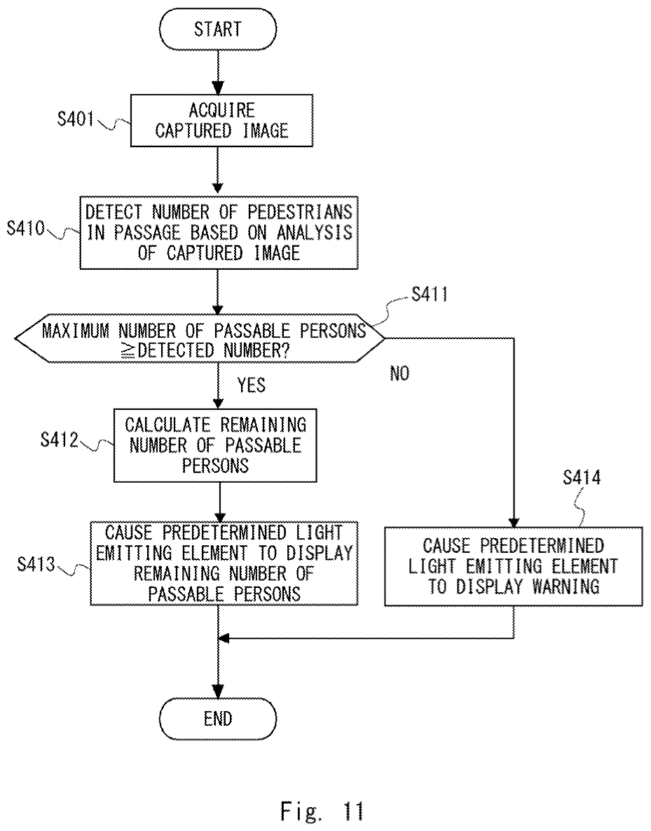

FIG. 11 is a flowchart illustrating a flow of passerby number monitoring processing according to the second example embodiment. The passage number monitoring processing is performed in parallel with the authentication control processing described above. Specifically, step S401 is similar to that in FIG. 8. Thereafter, step S410 and subsequent steps are performed in parallel with steps S402 and S404. That is, the detection unit 246 detects the number of pedestrians in the passage 400 from the captured image (S410). For example, the detection unit 246 analyzes the captured image and counts the number of regions corresponding to the pedestrians.

Next, the display control unit 245 determines whether the detected number of persons is equal to or smaller than the maximum number 212 of passable persons (S411). If YES in step S411, that is, if the detected number of persons is equal to or smaller than the maximum number 212 of passable persons, the calculation unit 247 calculates the remaining number of passable persons from the maximum number 212 of passable persons and the detected number of persons (S412). Then, the display control unit 245 performs display control in such a way as to cause a predetermined light emitting element to display the calculated remaining number of passable persons (S413).

On the other hand, if NO in step S411, that is, if the detected number of persons exceeds the maximum number 212 of passable persons, the display control unit 245 performs display control in such a way as to cause a predetermined light emitting element to display a warning (S414). The warning may be displayed in a manner in which a region where a pedestrian does not walk is illuminated, for example, light emitting elements buried in rows at both ends of the passage 400 emit red light. As a result, it is easy to keep an entrance of a pedestrian into the passage 400 within a range in which authentication can be performed by the authentication control apparatus 200. Therefore, the authentication control system 1000 can be stably operated.

Here, in the present example embodiment, in a case where the face authentication result indicates that the authentication has failed, the movement trajectory of the pedestrian may be displayed on the passage 400. For example, in a case where the face authentication result indicates that the authentication has failed, the display control unit 245 performs display control in such a way as to keep lighting of the light emitting element corresponding to the light emission target region. For example, the display 402 in FIG. 9 indicates a state in which the pedestrian U2 has failed in the face authentication many times in succession. Therefore, the pedestrian U2 can more appropriately recognize that the pedestrian U2 has failed in the face authentication. In addition, the surrounding security guards and the like can more appropriately recognize that the pedestrian U2 has failed in the face authentication, and can easily talk to the pedestrian U2.

It is assumed that the pedestrian U2 has succeeded in the face authentication thereafter. That is, in a case where the face authentication result indicates that the authentication has succeeded after an authentication failure, the display control unit 245 performs display control in such a way as to turn off the lighting of the light emitting element kept at the time of the authentication failure. As a result, the pedestrian U2 can more appropriately recognize that the pedestrian U2 has succeeded in the face authentication. The same applies to the security guards and the like.

In addition, the display of the movement trajectory may be implemented as follows. First, the authentication control apparatus 200 further includes a retention unit that extracts a body shape feature amount of a pedestrian from a captured image and retains the extracted body shape feature amount and a specified position in a history storage unit in association with each other. Then, in a case where the biometric authentication result indicates that the authentication has failed, the decision unit acquires a position associated with a body shape feature amount of a pedestrian who has failed in the authentication from the history storage unit, generates a movement trajectory of the pedestrian by using the acquired position, and decides the movement trajectory as the light emission target region. Thereafter, the display control unit performs display control for a light emitting element corresponding to the decided movement trajectory. As a result, the movement trajectory of walking from the start of the authentication to the determination of the authentication result can be displayed at a timing when the authentication result has been determined.

A difference in display mode between a case where the authentication result indicates success and a case where the authentication result indicates failure may be as follows. First, the display control unit 245 performs display control in such a way as to cause the light emitting element corresponding to the light emission target region to perform first lighting during a period from when the position is specified to when a biometric authentication result of the pedestrian is acquired. The first lighting is, for example, yellow lighting. Next, after the biometric authentication result is acquired, the display control unit 245 selects any one of second lighting and third lighting according to whether the biometric authentication result indicates success or failure. For example, the second lighting is blue lighting and is performed in a case where the face authentication has succeeded, and the third lighting is red lighting and is performed in a case where the face authentication has succeeded. Then, the display control unit 245 performs display control in such a way as to cause the light emitting element corresponding to the light emission target region to perform the selected lighting. The second lighting and the third lighting may have higher brightness than the first lighting. Alternatively, no lighting may be performed instead of the first lighting. That is, during the authentication, no lighting may be performed, and the lighting may be performed according to the authentication result at a timing when the authentication result has been determined. Even in this case, it is possible to appropriately notify a pedestrian, a security guard, and the like of the difference in authentication result.

In the present example embodiment, success or failure indicated by the authentication result may be displayed in a distinguishable manner between an employee of a facility and a guest. In this case, it is assumed that the storage unit 210 stores in advance a user ID of the employee, an attribute (affiliation), and the like in association with each other. Then, the decision unit 244 specifies the attribute of the pedestrian based on the biometric authentication result. For example, in a case where the biometric authentication result indicates success, the decision unit 244 specifies a user ID included in the biometric authentication result and acquires an attribute associated with the specified user ID from the storage unit 210. In a case where the attribute can be acquired, since the pedestrian is an employee, the decision unit 244 decides a less conspicuous display mode as compared to a guest. Alternatively, in a case where the pedestrian is an employee, the decision unit 244 decides a narrower light emission target region than that for a guest. In other words, in a case where the attribute cannot be acquired, since the user is a guest, the decision unit 244 decides a more conspicuous display mode than that for an employee. Alternatively, in a case where the pedestrian is a guest, the decision unit 244 decides a wider light emission target region than that for an employee. Accordingly, it is possible to improve a service for a guest.

### Third Example Embodiment

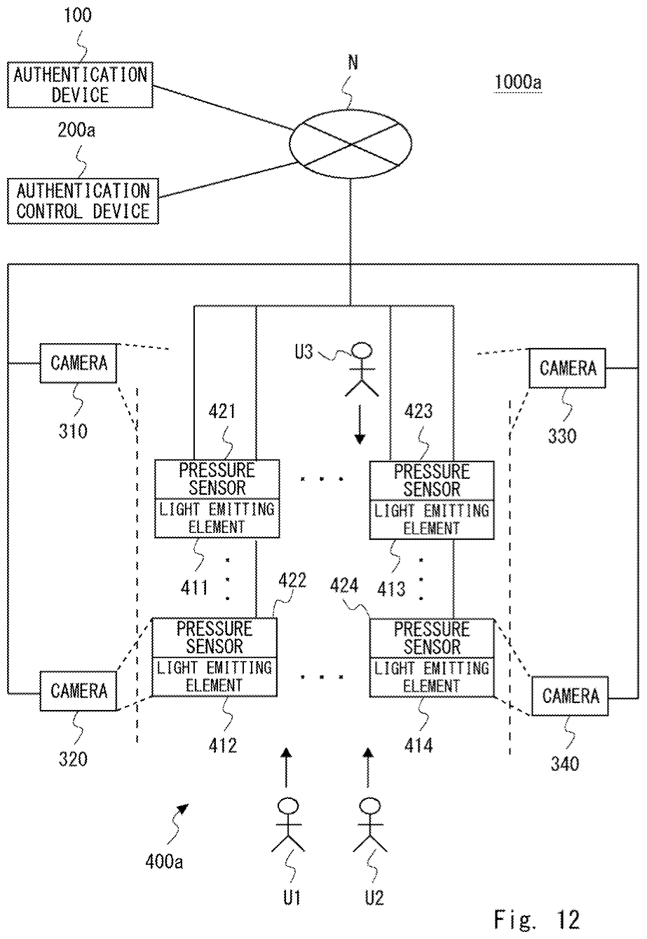

A third example embodiment is a modification of the second example embodiment described above. In the third example embodiment, a pressure sensor is used in addition to image analysis to specify a position of a pedestrian. FIG. 12 is a block diagram illustrating an overall configuration of an authentication control system 1000a according to the third example embodiment. The authentication control system 1000a is different from the authentication control system 1000 described above in that the authentication control apparatus 200 is replaced with an authentication control apparatus 200a, and pressure sensors 421 to 424 are added. Other configurations are equivalent to those of the authentication control system 1000.

Each of the pressure sensors 421 to 424 corresponds to each of light emitting elements 411 to 414 and is embedded under the floor of a passage 400a. Each of the pressure sensors 421 to 424 is connected to the network N. Each of the pressure sensors 421 to 424 notifies the authentication control apparatus 200a of a detection result via the network N in a case where an addition is applied by any feet of the pedestrians U1 to U3, and a pressure equal to or higher than a certain level is detected. The detection result includes position information of the pressure sensor.

Since the configuration diagram of the authentication control apparatus 200a is the same as that in FIG. 7, illustration thereof is omitted. However, in the authentication control apparatus 200a, a program 211, an acquisition unit 241, and a position specification unit 243 are different from those of the authentication control apparatus 200. The program 211 embedded in the storage unit 210 of the authentication control apparatus 200a is a computer program in which processing of an authentication control method according to the third example embodiment is implemented. The acquisition unit 241 included in the authentication control apparatus 200a further has a function of detection result acquisition means for acquiring a result of detection by the pressure sensor. The position specification unit 243 included in the authentication control apparatus 200a specifies a position of a pedestrian on the passage 400a in further consideration of the detection result.

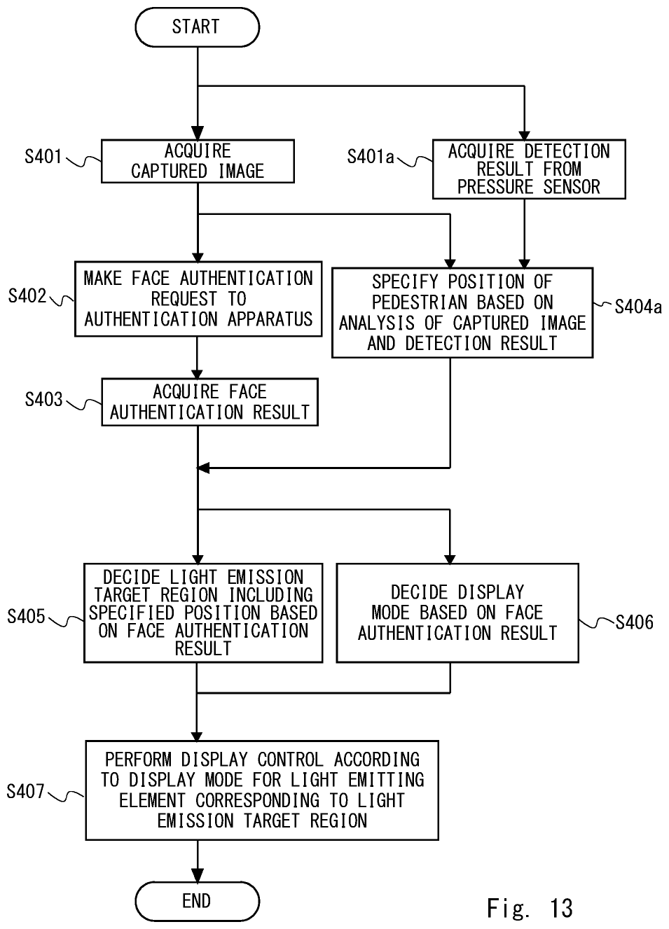

FIG. 13 is a flowchart illustrating a flow of the authentication control method according to the third example embodiment. Steps S401 to S403 and steps S405 to S407 are similar to those in FIG. 8 described above. Independently of step S401, the acquisition unit 241 acquires a detection result from each of the pressure sensors 421 to 424 via the network N (S401a). After steps S401 and S401a, the position specification unit 243 specifies the position of the pedestrian based on analysis of the captured image and the detection result (S404a). The subsequent steps are similar to those in FIG. 8.

As described above, in the third example embodiment, the detection result of the pressure sensor is used in addition to image analysis for specifying the position of the pedestrian. Therefore, in addition to the effect similar to that of the second example embodiment, the accuracy in specifying the position of the pedestrian is improved as compared with the second example embodiment.

### Fourth Example Embodiment

A fourth example embodiment is a modification of the second and third example embodiments described above. In recent years, from the viewpoint of preventing the spread of infectious diseases, not only collation with information registered in advance but also confirmation of a health condition of a person at the time of entrance has been increasingly performed for determination of entrance qualification. Therefore, also in a walk-through authentication system, it is desirable to perform display based on a body surface temperature of a pedestrian in addition to biometric authentication. Therefore, in the fourth example embodiment, display control based on a body surface temperature measured from a pedestrian is performed in addition to the processing in the second and third example embodiments described above.

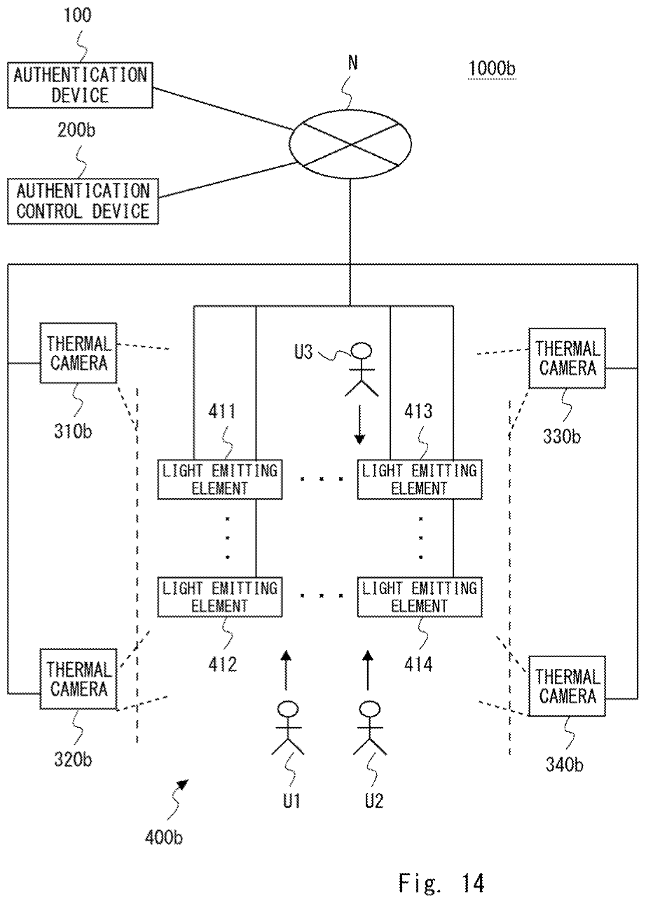

FIG. 14 is a block diagram illustrating an overall configuration of an authentication control system according to the fourth example embodiment. In an authentication control system 1000b is different from the authentication control system 1000 described above in that the authentication control apparatus 200 is replaced with an authentication control apparatus 200b, and the cameras 310 to 340 are replaced with thermal cameras 310a to 340a. Other configurations are equivalent to those of the authentication control system 1000.

Each of the thermal cameras 310a to 340a is installed at a gate of a passage 400b and connected to the network N. Each of the thermal cameras 310a to 340a is a device including a predetermined imaging device and a body surface temperature measurement device. The imaging device may be, for example, a stereo camera. The thermal camera 310a or the like captures an image of bodies including the faces of the pedestrians U1 to U3, and transmits the captured image to the authentication control apparatus 200b via the network N. The thermal camera 310a or the like measures a temperature in an imaging target region, generates a thermographic image showing a temperature distribution, and transmits the thermographic image to the authentication control apparatus 200b via the network N.

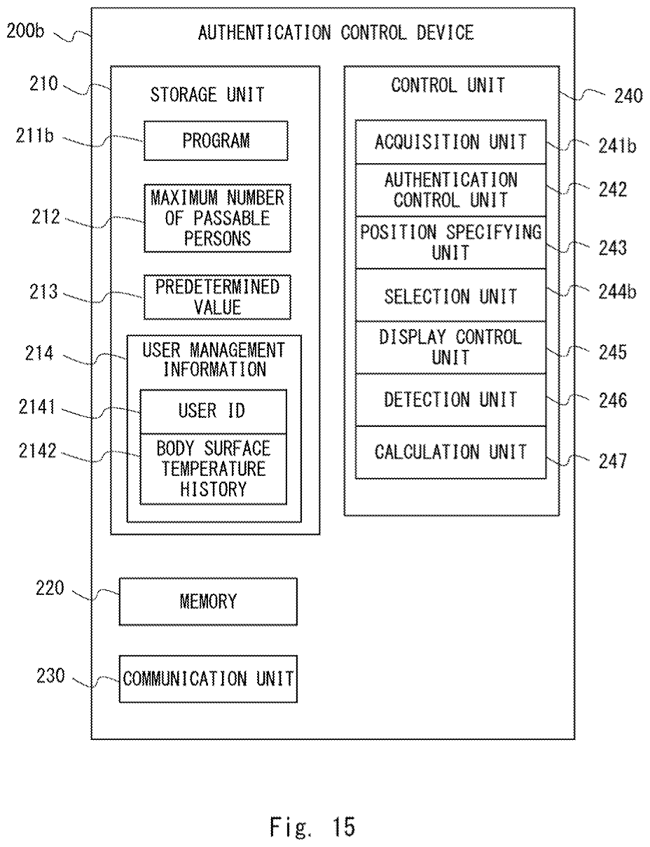

FIG. 15 is a block diagram illustrating a configuration of an authentication control apparatus 200b according to the fourth example embodiment. A storage unit 210 of the authentication control apparatus 200b is different from that of the authentication control apparatus 200 described above in that the program 211 is replaced with a program 211b, and a predetermined value 213 and user management information 214 are added. In addition, a control unit 240 of the authentication control apparatus 200b is different from that of the authentication control apparatus 200 described above in that the acquisition unit 241 and the decision unit 244 are replaced with an acquisition unit 241b and a decision unit 244b. Other components are equivalent to those of the authentication control apparatus 200.

The program 211b is a computer program in which the processing of an authentication control method according to the fourth example embodiment is implemented. The predetermined value 213 is a threshold for body surface temperature comparison. For example, the predetermined value 213 may be 37.5 degrees. The user management information 214 is information for managing user information. The user management information 214 is information in which a user ID 2141 and a body surface temperature history 2142 are associated with each other. The body surface temperature history 2142 is a body surface temperature measurement history of a corresponding user (pedestrian). For example, in a case where the pedestrian is an employee, since the body surface temperature is measured by the thermal camera 310a or the like every day, the body surface temperature history 2142 may be added to the user management information 214 in association with the user ID 2141 each time. The body surface temperature history 2142 may be an average value of measured values. For example, the average value may be calculated again each time the measurement is performed.

The acquisition unit 241b further has a function of body surface temperature acquisition means for acquiring a body surface temperature measured from a pedestrian. In a case where the body surface temperature is equal to or higher than the predetermined value 213, the decision unit 244b decides at least one of a display mode or a light emission target region in such a way that the display mode or the light emission target region is more highlighted than in a case where the body surface temperature is lower than the predetermined value 213. Specifically, in a case where the body surface temperature is equal to or higher than the predetermined value 213, the decision unit 244b may select a different light emission color, a different blinking pattern, a different luminance, and a different size of the light emission target region from those for other cases. For example, in this case, the decision unit 244b decides a light emission color different from the above, a shorter blinking pattern than usual, a higher luminance than usual, and a wider light emission target region than usual. Further, the decision unit 244b may select the predetermined value 213 based on the body surface temperature history 2142 of the pedestrian, and may determine at least one of the display mode or the light emission target region according to a result of comparison between the acquired body surface temperature and the decided predetermined value 213.

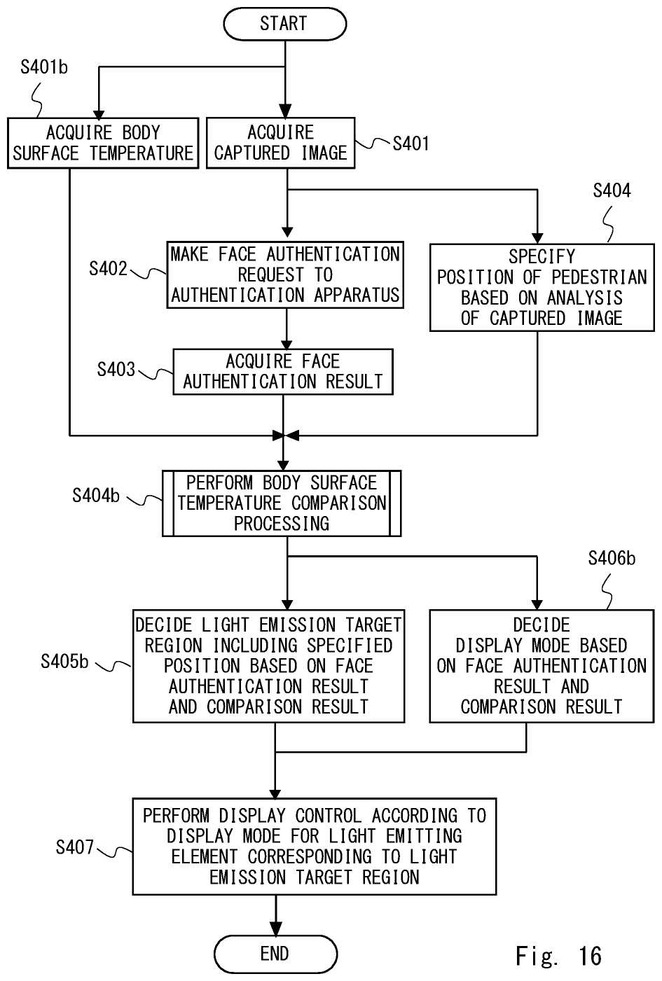

FIG. 16 is a flowchart illustrating a flow of an authentication control method according to the fourth example embodiment. Here, the thermal camera 310a or the like captured an image of the pedestrians U1 to U3, measures the temperatures, and generates a thermographic image. Then, the thermal camera 310a or the like transmits the captured image and the thermographic image to the authentication control apparatus 200b via the network N. Steps S401 to S404 and S407 are similar to those in FIG. 8 described above.

In parallel with step S401, the acquisition unit 241b receives the thermographic image from each of the thermal cameras 310a to 340a via the network N, collates the thermographic image with the captured image, and acquires the body surface temperature of the face region of each pedestrian (S401b).

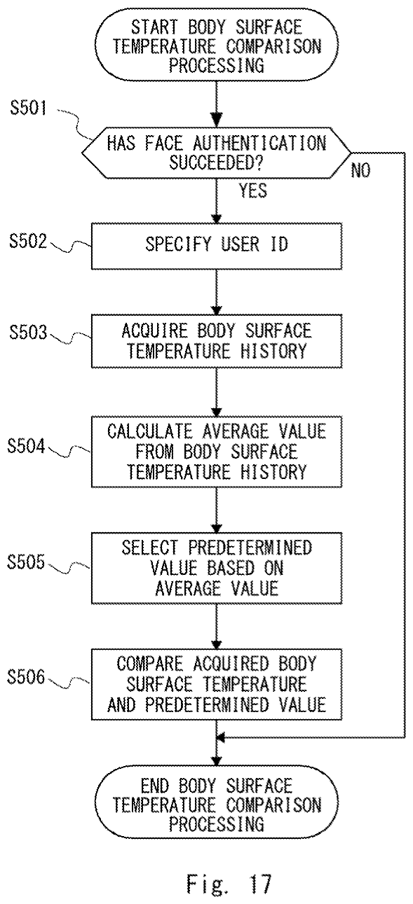

After steps S403, S404, and S401b, the decision unit 244b performs body surface temperature comparison processing (S404b). FIG. 17 is a flowchart illustrating a flow of the body surface temperature comparison processing according to the fourth example embodiment. First, the decision unit 244b determines whether or not face authentication has succeeded (S501). Specifically, the decision unit 244b determines whether the face authentication result acquired in step S403 indicates success or failure. In a case where it is determined that the authentication has succeeded, the decision unit 244b specifies a user ID included in the face authentication result (S502). Then, the decision unit 244b acquires the body surface temperature history 2142 associated with the specified user ID 2141 from the user management information 214 (S503). Subsequently, the decision unit 244b calculates an average value from the acquired body surface temperature history 2142 (S504). Then, the decision unit 244b decides the predetermined value 213 based on the calculated average value (S505). For example, the decision unit 244b decides (updates), as the predetermined value 213, a temperature obtained by adding 1 degree to the calculated average value. Thereafter, the decision unit 244b compares the body surface temperature acquired in step S401b with the decided predetermined value 213, and obtains a comparison result (S506). In a case where it is determined in step S501 that the authentication has failed, it is determined that there is no comparison result, and the processing returns to FIG. 16.

Returning to FIG. 16, the description will be continued. After step S404b, the decision unit 244b decides a light emission target region including the specified position based on the face authentication result and the comparison result (S405b). For example, in a case where the comparison result indicates that the body surface temperature is equal to or higher than the predetermined value, the decision unit 244b may select a wider light emission target region than that in a case where the comparison result indicates that the body surface temperature is lower than the predetermined value.

In addition, the decision unit 244b decides a display mode based on the face authentication result and the comparison result (S406b). For example, in a case where the comparison result indicates that the body surface temperature is equal to or higher than the predetermined value, the decision unit 244b may select the display mode such as a different color (other than red and blue) or different blinking from those in a case where the comparison result indicates that the body surface temperature is lower than the predetermined value. Steps S405b and S406b may be performed in parallel or in series.

After steps S405 and S406, the display control unit 245 performs display control according to the display mode for a light emitting element corresponding to the light emission target region (S407). As a result, the pedestrian can easily recognize a possibility that his/her body temperature is high, and a security guard or the like can easily recognize the possibility, and can easily talk to the pedestrian.

As described above, the same effects as those of the above-described example embodiments can be achieved by the present example embodiment. Furthermore, the present example embodiment can also contribute to prevention of the spread of infectious diseases.

### Fifth Example Embodiment

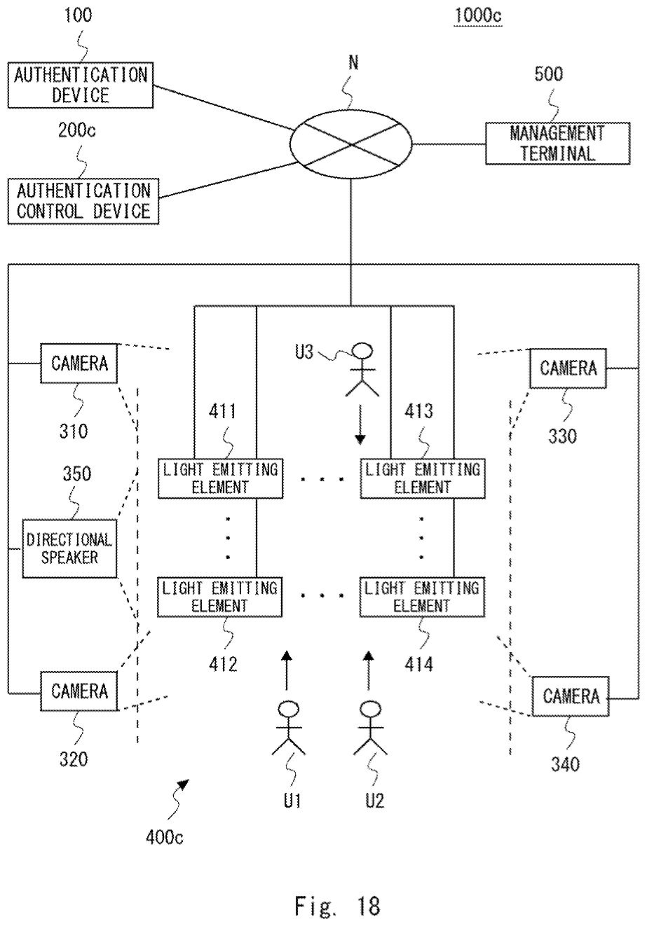

A fifth example embodiment is a modification of the second to fourth example embodiments described above. In the fifth example embodiment, notification by a speaker or output to a terminal for a manager is performed according to a face authentication result. FIG. 18 is a block diagram illustrating an overall configuration of an authentication control system 100c according to the fifth example embodiment. The authentication control system 1000c is different from the authentication control system 1000 described above in that the authentication control apparatus 200 is replaced with an authentication control apparatus 200c, and a directional speaker 350 and a management terminal 500 are added. Other configurations are equivalent to those of the authentication control system 1000.

The directional speaker 350 is a speaker with high directivity installed in a passage 400c. Therefore, the directional speaker 350 can transmit sound waves more clearly than usual in an output direction. The directional speaker 350 is connected to the network N and outputs a predetermined warning in the output direction indicated by the authentication control apparatus 200c.

The management terminal 500 is an information processing apparatus operated and browsed by a security guard or a staff of a facility. The management terminal 500 is connected to the network N, and displays a captured image and a biometric authentication result received from the authentication control apparatus 200c on a screen.

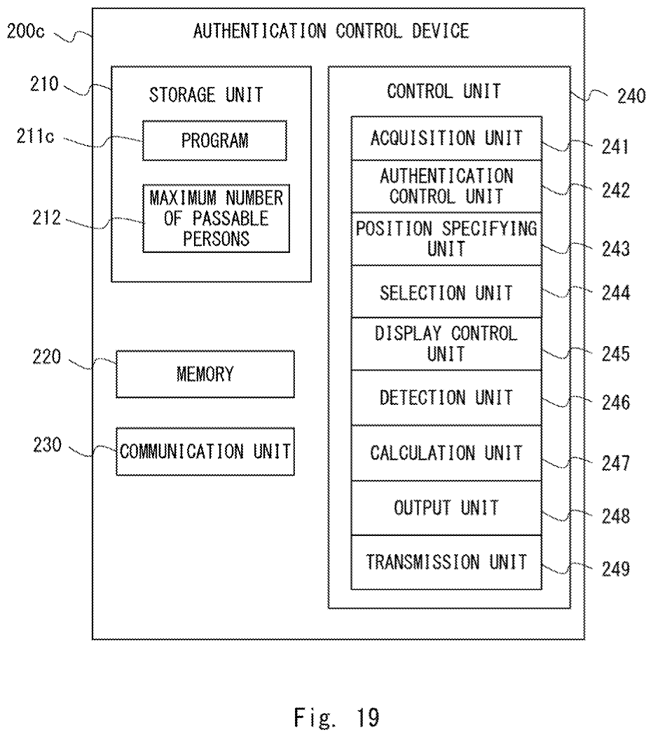

FIG. 19 is a block diagram illustrating a configuration of the authentication control apparatus 200c according to the fifth example embodiment. The authentication control apparatus 200c is different from the authentication control apparatus 200 described above in that the program 211 is replaced with a program 211c, and an output unit 248 and a transmission unit 249 are added. Other components are equivalent to those of the authentication control apparatus 200.

The program 211c is a computer program in which the processing of an authentication control method according to the fifth example embodiment is implemented. In a case where the biometric authentication result indicates that the authentication has failed, the output unit 248 outputs a predetermined warning for the specified position to the directional speaker 350 via the network N. Alternatively, the output unit 248 may output a predetermined warning toward a standing position of a security guard. In a case where the biometric authentication result indicates that the authentication has failed, the transmission unit 249 transmits the captured image and the biometric authentication result to the management terminal 500 via the network N.

The authentication control apparatus 200c may acquire a body surface temperature measured from a pedestrian as in the fourth example embodiment described above. At this time, in a case where the body surface temperature is equal to or higher than a predetermined value, the output unit 248 may further output the predetermined warning. In addition, in a case where the body surface temperature is equal to or higher than the predetermined value, the transmission unit 249 may further transmit the body surface temperature or a determination result thereof to the management terminal 500 via the network N. Alternatively, in a case where the body surface temperature is equal to or higher than the predetermined value, the transmission unit 249 may transmit display information based on the body surface temperature or the determination result, or information designating a display mode or a display region to the management terminal 500 via the network N. Here, the display mode may be a color, a blinking pattern, or a luminance in the screen of the management terminal 500. In addition, the display region is a region in which the captured image, the biometric authentication result, the body surface temperature, and the like are displayed in the screen of the management terminal 500. For example, in a case where the body surface temperature is equal to or higher than the predetermined value, a display mode or display region different from that in a case where the face authentication has failed may be used. Specifically, in a case where the body surface temperature is equal to or higher than the predetermined value, a different screen color, a shorter blinking pattern, a higher luminance, and a wider display region than those in a case where the face authentication has failed. As a result, it is possible to further emphasize that it is necessary to check the health condition.

As described above, the same effects as those of the above-described example embodiments can be achieved by the present example embodiment. Furthermore, according to the present example embodiment, it is possible to more clearly notify a pedestrian himself/herself or a security guard that authentication has failed. In addition, a pedestrian, a security guard, and a staff can more easily recognize a difference in authentication result.

### Sixth Example Embodiment

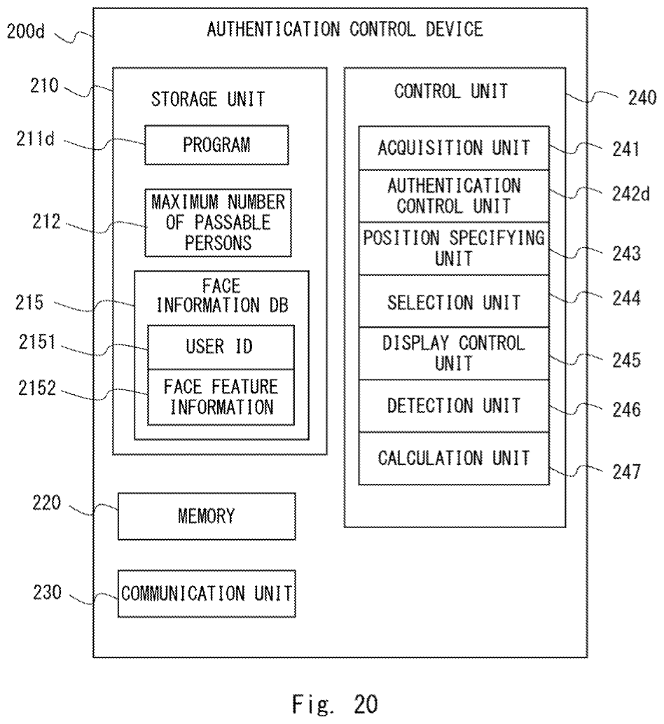

A sixth example embodiment is a modification of the second example embodiment described above. FIG. 20 is a block diagram illustrating a configuration of an authentication control apparatus 200d according to the sixth example embodiment. A storage unit 210 of the authentication control apparatus 200d is different from that of the authentication control apparatus 200 described above in that the program 211 is replaced with a program 211d, and a face information DB 215 is added. In addition, a control unit 240 of the authentication control apparatus 200d is different from the authentication control apparatus 200 described above in that the authentication control unit 242 is replaced with an authentication control unit 242d.

The program 211d is a computer program in which the processing of an authentication control method according to the sixth example embodiment is implemented.

The face information DB 215 corresponds to the face information DB 110 of the authentication apparatus 100 described above, and a plurality of user IDs 2151 and face feature information 2152 are associated with each other.

The authentication control unit 242d collates face feature information extracted from a face region of a user (pedestrian) included in an acquired captured image with the face feature information 2152 stored in the storage unit 210 to perform face authentication, thereby acquiring a face authentication result.

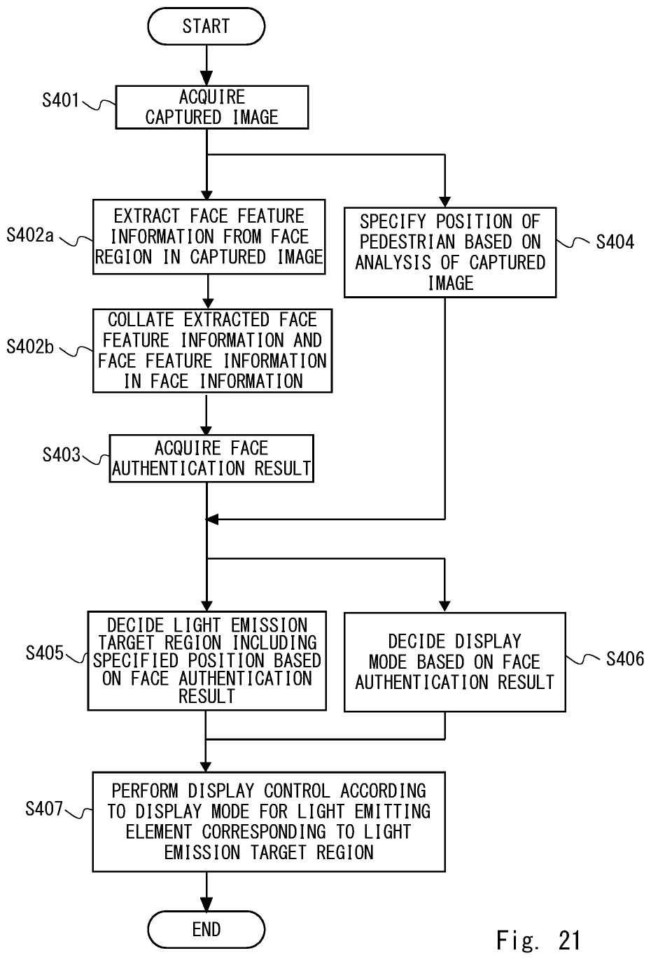

FIG. 21 is a flowchart illustrating a flow of an authentication control method according to the sixth example embodiment. In FIG. 21, step S402 in FIG. 8 described above is replaced with steps S402a and S402b.

After step S401, the acquisition unit 241 extracts face feature information from a face region of each user in an acquired captured image (S402a). Then, the authentication control unit 242d collates the extracted face feature information with the face feature information 2152 in the face information DB 214 for each user (S402b).

As described above, the same effects as those of the second example embodiment described above can be achieved by the sixth example embodiment. It goes without saying that the sixth example embodiment may be a modification of the third to fifth example embodiments.

### Other Embodiments and the Like

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following supplementary notes, but are not limited to the following.

(Supplementary Note A1)

An authentication control apparatus including:
biometric information acquisition means for acquiring biometric information of a pedestrian on a predetermined passage in which a plurality of light emitting elements are embedded from a captured image of the pedestrian;
authentication control means for acquiring a biometric authentication result obtained using the acquired biometric information and biometric information of a plurality of persons;
position specification unit for specifying a position of the pedestrian on the passage by analyzing the captured image; and
display control means for performing display control related to the biometric authentication result for the light emitting element corresponding to a light emission target region including the specified position.

(Supplementary Note A2)

The authentication control apparatus according to Supplementary Note A1, further including decision means for deciding a display mode and the light emission target region based on the biometric authentication result,
in which the display control means performs display control according to the decided display mode for the light emitting element corresponding to the decided light emission target region.

(Supplementary Note A3)

The authentication control apparatus according to Supplementary Note A2,
in which in a case where the biometric authentication result indicates that authentication has failed, the decision means decides the light emission target region wider than that in a case where the biometric authentication result indicates that the authentication has succeeded.

(Supplementary Note A4)

The authentication control apparatus according to Supplementary Note A2 or A3,
in which in a case where the biometric authentication result indicates that the authentication has failed, the decision means decides the light emission target region including a traveling direction of the pedestrian predicted from the captured image.

(Supplementary Note A5)

The authentication control apparatus according to any one of Supplementary Notes A2 to A4,
in which the decision means decides at least one of a different light emission color or a different light emission pattern as the display mode according to whether the biometric authentication result indicates success or failure.

(Supplementary Note A6)

The authentication control apparatus according to Supplementary Note A5,
in which in a case where the biometric authentication result indicates that the authentication has failed, the decision means decides the display mode in such a way that a light emission time is longer than that in a case where the biometric authentication result indicates that the authentication has succeeded.

(Supplementary Note A7)

The authentication control apparatus according to Supplementary Note A5 or A6,
in which in a case where the biometric authentication result indicates that the authentication has failed, the decision means decides the display mode in such a way that the display mode is more highlighted than in a case where the biometric authentication result indicates that the authentication has succeeded.

(Supplementary Note A8)

The authentication control apparatus according to any one of Supplementary Notes A2 to A7,
in which the decision means specifies an attribute of the pedestrian based on the biometric authentication result, and decides at least one of the display mode or the light emission target region according to the specified attribute.

(Supplementary Note A9)

The authentication control apparatus according to any one of Supplementary Notes A2 to A8, further including body surface temperature acquisition means for acquiring a body surface temperature measured from the pedestrian,
in which in a case where the body surface temperature is equal to or higher than a predetermined value, the decision means decides at least one of the display mode or the light emission target region in such a way that the display mode or the light emission target region is more highlighted than in a case where the body surface temperature is lower than the predetermined value.

(Supplementary Note A10)

The authentication control apparatus according to Supplementary Note A9,
in which the decision means decides the predetermined value based on a body surface temperature history of the pedestrian, and decides at least one of the display mode or the light emission target region according to a result of comparison between the acquired body surface temperature and the decided predetermined value.

(Supplementary Note A11)

The authentication control apparatus according to any one of Supplementary Notes A2 to A10, further including retention means for extracting a body shape feature amount of the pedestrian from the captured image and retaining the extracted body shape feature amount and the specified position in association with each other in history storage means, in which
in a case where the biometric authentication result indicates that the authentication has failed, the decision means acquires a position associated with a body shape feature amount of a pedestrian who has failed in the authentication from the history storage means, generates a movement trajectory of the pedestrian by using the acquired position, and decides the movement trajectory as the light emission target region, and
the display control means performs the display control for the light emitting element corresponding to the decided movement trajectory.

(Supplementary Note A12)

The authentication control apparatus according to any one of Supplementary Notes A1 to A11, in which
the display control means performs display control in such a way as to cause the light emitting element corresponding to the light emission target region to perform first lighting during a period from when the position is specified to when the biometric authentication result of the pedestrian is acquired, and
after the biometric authentication result is acquired, the display control means selects any one of second lighting and third lighting according to whether the biometric authentication result indicates success or failure, and performs display control in such a way as to cause the light emitting element corresponding to the light emission target region to perform the selected lighting.

(Supplementary Note A13)

The authentication control apparatus according to any one of Supplementary Notes A1 to A12,
in which the display control means performs display control in such a way as to keep lighting of the light emitting element corresponding to the light emission target region in a case where the biometric authentication result indicates that the authentication has failed.

(Supplementary Note A14)

The authentication control apparatus according to Supplementary Note A13,
in which in a case where the biometric authentication result indicates that the authentication has succeeded after an authentication failure, the display control means performs display control in such a way as to turn off the lighting of the light emitting element kept at a time of the authentication failure.

(Supplementary Note A15)

The authentication control apparatus according to any one of Supplementary Notes A1 to A14, in which
pressure sensors corresponding to the plurality of light emitting elements, respectively, are further embedded in the passage,
the authentication control apparatus further includes detection result acquisition means for acquiring a detection result from the pressure sensor, and
the position specification unit specifies the position further in consideration of the detection result.

(Supplementary Note A16)

The authentication control apparatus according to any one of Supplementary Notes A1 to A15, further including
output means for outputting a predetermined warning for the specified position to a speaker with high directivity installed in the passage in a case where the biometric authentication result indicates that the authentication has failed.

(Supplementary Note A17)

The authentication control apparatus according to any one of Supplementary Notes A1 to A16, further including:
detection means for detecting the number of persons in the passage from the captured image; and
calculation means for calculating a remaining number of passable persons from a maximum number of passable persons of the passage and the detected number of persons, in which
the display control means performs display control in such a way as to cause a predetermined light emitting element to display the calculated number of passable persons, and
the display control means performs display control in such a way as to cause the predetermined light emitting element to display a warning in a case where the detected number of persons exceeds the maximum number of passable persons.

(Supplementary Note A18)

The authentication control apparatus according to any one of Supplementary Notes A1 to A17, further including
transmission means for transmitting the captured image and the biometric authentication result to a predetermined information processing apparatus via a network in a case where the biometric authentication result indicates that the authentication has failed.

(Supplementary Note A19)

The authentication control apparatus according to any one of Supplementary Notes A1 to A18,
in which the authentication control means causes an authentication apparatus that stores the biometric information of the plurality of persons to perform the authentication using the biometric information acquired from the captured image, and acquires the biometric authentication result from the authentication apparatus.

(Supplementary Note A20)

The authentication control apparatus according to any one of Supplementary Notes A1 to A18, further including storage means for storing the biometric information of the plurality of persons,
in which the authentication control means acquires the biometric authentication result by performing the authentication by collating the biometric information of the plurality of persons with the biometric information acquired from the captured image.

(Supplementary Note B1)

An authentication control system including:
a plurality of light emitting elements embedded in a predetermined passage;
an imaging device; and
an authentication control apparatus connected to the plurality of light emitting elements and the imaging device,
in which the authentication control apparatus includes:
biometric information acquisition means for acquiring biometric information of a pedestrian on the passage from a captured image of the pedestrian captured by the imaging device;
authentication control means for acquiring a biometric authentication result obtained using the acquired biometric information and biometric information of a plurality of persons;
position specification unit for specifying a position of the pedestrian on the passage by analyzing the captured image; and
display control means for performing display control related to the biometric authentication result for the light emitting element corresponding to a light emission target region including the specified position.

(Supplementary Note B2)

The authentication control system according to Supplementary Note B1, in which
the authentication control apparatus further includes decision means for deciding a display mode and the light emission target region based on the biometric authentication result, and
the display control means performs display control according to the decided display mode for the light emitting element corresponding to the decided light emission target region.

(Supplementary Note C1)

An authentication control method performed by a computer, the authentication control method including:
acquiring biometric information of a pedestrian on a predetermined passage in which a plurality of light emitting elements are embedded from a captured image of the pedestrian;
acquiring a biometric authentication result obtained using the acquired biometric information and biometric information of a plurality of persons;
specifying a position of the pedestrian on the passage by analyzing the captured image; and
performing display control related to the biometric authentication result for the light emitting element corresponding to a light emission target region including the specified position.

(Supplementary Note D1)

A non-transitory computer-readable medium storing an authentication control program that causes a computer to perform:
biometric information acquisition processing of acquiring biometric information of a pedestrian on a predetermined passage in which a plurality of light emitting elements are embedded from a captured image of the pedestrian;
authentication control processing of acquiring a biometric authentication result obtained using the acquired biometric information and biometric information of a plurality of persons;
position specifying processing of specifying a position of the pedestrian on the passage by analyzing the captured image; and
display control processing of performing display control related to the biometric authentication result for the light emitting element corresponding to a light emission target region including the specified position.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### REFERENCE SIGNS LIST

10 AUTHENTICATION CONTROL APPARATUS
11 BIOMETRIC INFORMATION ACQUISITION UNIT
12 AUTHENTICATION CONTROL UNIT
13 POSITION SPECIFICATION UNIT
14 DISPLAY CONTROL UNIT
1000 AUTHENTICATION CONTROL SYSTEM
1000a AUTHENTICATION CONTROL SYSTEM
1000b AUTHENTICATION CONTROL SYSTEM
1000c AUTHENTICATION CONTROL SYSTEM
1000d AUTHENTICATION CONTROL SYSTEM
100 AUTHENTICATION APPARATUS
110 FACE INFORMATION DB
111 USER ID
112 FACE FEATURE INFORMATION
120 FACE DETECTION UNIT
130 FEATURE POINT EXTRACTION UNIT
140 REGISTRATION UNIT
150 AUTHENTICATION UNIT
200 AUTHENTICATION CONTROL APPARATUS
200a AUTHENTICATION CONTROL APPARATUS
200b AUTHENTICATION CONTROL APPARATUS
200c AUTHENTICATION CONTROL APPARATUS
200d AUTHENTICATION CONTROL APPARATUS
210 STORAGE UNIT
211 PROGRAM
211b PROGRAM
211c PROGRAM
211d PROGRAM
212 MAXIMUM NUMBER OF PASSABLE PERSONS
213 PREDETERMINED VALUE
214 USER MANAGEMENT INFORMATION
2141 USER ID
2142 BODY SURFACE TEMPERATURE HISTORY
215 FACE INFORMATION DB
2151 USER ID
2152 FACE FEATURE INFORMATION
220 MEMORY
230 COMMUNICATION UNIT
240 CONTROL UNIT
241 ACQUISITION UNIT
241b ACQUISITION UNIT
242 AUTHENTICATION CONTROL UNIT
242d AUTHENTICATION CONTROL UNIT
243 POSITION SPECIFICATION UNIT
244 DECISION UNIT
244b DECISION UNIT
245 DISPLAY CONTROL UNIT
246 DETECTION UNIT
247 CALCULATION UNIT
248 OUTPUT UNIT
249 TRANSMISSION UNIT
310 CAMERA
320 CAMERA
330 CAMERA
340 CAMERA
310a THERMAL CAMERA
320a THERMAL CAMERA
330a THERMAL CAMERA
340a THERMAL CAMERA
350 DIRECTIONAL SPEAKER
400 PASSAGE
400a PASSAGE
400b PASSAGE
400c PASSAGE
401 DISPLAY
402 DISPLAY
402a DISPLAY
403 DISPLAY
411 LIGHT EMITTING ELEMENT
412 LIGHT EMITTING ELEMENT
413 LIGHT EMITTING ELEMENT
414 LIGHT EMITTING ELEMENT
421 PRESSURE SENSOR
422 PRESSURE SENSOR
423 PRESSURE SENSOR
424 PRESSURE SENSOR
500 MANAGEMENT TERMINAL
N NETWORK
U1 PEDESTRIAN
U2 PEDESTRIAN
U3 PEDESTRIAN

What is claimed is:

1. An authentication control apparatus comprising:
at least one storage device configured to store instructions; and
at least one processor configured to execute the instructions to:
acquire biometric information of a pedestrian on a predetermined passage in which a plurality of light emitting elements are embedded from a captured image of the pedestrian;
acquire a biometric authentication result obtained using the acquired biometric information and biometric information of a plurality of persons;
specify a position of the pedestrian on the passage by analyzing the captured image; and
perform display control related to the biometric authentication result for the light emitting element corresponding to a light emission target region including the specified position.

2. The authentication control apparatus according to claim 1,
wherein the at least one processor is further configured to execute the instructions to:
decide a display mode and the light emission target region based on the biometric authentication result, and
perform display control according to the decided display mode for the light emitting element corresponding to the decided light emission target region.

3. The authentication control apparatus according to claim 2,
wherein the at least one processor is further configured to execute the instructions to:
in a case where the biometric authentication result indicates that authentication has failed, decide the light emission target region wider than that in a case where the biometric authentication result indicates that the authentication has succeeded.

4. The authentication control apparatus according to claim 2,
wherein the at least one processor is further configured to execute the instructions to:
in a case where the biometric authentication result indicates that the authentication has failed, decide the light emission target region including a traveling direction of the pedestrian predicted from the captured image.

5. The authentication control apparatus according to any one of claim 2,
wherein the at least one processor is further configured to execute the instructions to:
decide at least one of a different light emission color or a different light emission pattern as the display mode according to whether the biometric authentication result indicates success or failure.

6. The authentication control apparatus according to claim 5,
wherein the at least one processor is further configured to execute the instructions to:
in a case where the biometric authentication result indicates that the authentication has failed, decide the display mode in such a way that a light emission time is longer than that in a case where the biometric authentication result indicates that the authentication has succeeded.

7. The authentication control apparatus according to claim 5,
wherein the at least one processor is further configured to execute the instructions to:
in a case where the biometric authentication result indicates that the authentication has failed, decide the display mode in such a way that the display mode is more highlighted than in a case where the biometric authentication result indicates that the authentication has succeeded.

8. The authentication control apparatus according to claim 2,
wherein the at least one processor is further configured to execute the instructions to:
specify an attribute of the pedestrian based on the biometric authentication result, and decide at least one of the display mode or the light emission target region according to the specified attribute.

9. The authentication control apparatus according to claim 2,
wherein the at least one processor is further configured to execute the instructions to:
acquire a body surface temperature measured from the pedestrian,
in a case where the body surface temperature is equal to or higher than a predetermined value, decide at least one of the display mode or the light emission target region in such a way that the display mode or the light emission target region is more highlighted than in a case where the body surface temperature is lower than the predetermined value.

10. The authentication control apparatus according to claim 9,
wherein the at least one processor is further configured to execute the instructions to:
decide the predetermined value based on a body surface temperature history of the pedestrian, and decide at least one of the display mode or the light emission target region according to a result of comparison between the acquired body surface temperature and the decided predetermined value.

11. The authentication control apparatus according to claim 2,
wherein the at least one processor is further configured to execute the instructions to:
extract a body shape feature amount of the pedestrian from the captured image and retain the extracted body shape feature amount and the specified position in association with each other in history storage device, and
in a case where the biometric authentication result indicates that the authentication has failed, acquire a position associated with a body shape feature amount of a pedestrian who has failed in the authentication from the history storage device, generate a movement trajectory of the pedestrian by using the acquired position, and decide the movement trajectory as the light emission target region, and
perform the display control for the light emitting element corresponding to the decided movement trajectory.

12. The authentication control apparatus according to claim 1, wherein the at least one processor is further configured to execute the instructions to:
perform display control in such a way as to cause the light emitting element corresponding to the light emission target region to perform first lighting during a period from when the position is specified to when the biometric authentication result of the pedestrian is acquired, and
after the biometric authentication result is acquired, select any one of second lighting and third lighting according to whether the biometric authentication result indicates success or failure, and perform display control in such a way as to cause the light emitting element corresponding to the light emission target region to perform the selected lighting.

13. The authentication control apparatus according to claim 1,
wherein the at least one processor is further configured to execute the instructions to:
perform display control in such a way as to keep lighting of the light emitting element corresponding to the light emission target region in a case where the biometric authentication result indicates that the authentication has failed.

14. The authentication control apparatus according to claim 13,
wherein the at least one processor is further configured to execute the instructions to:
in a case where the biometric authentication result indicates that the authentication has succeeded after an authentication failure, perform display control in such a way as to turn off the lighting of the light emitting element kept at a time of the authentication failure.

15. The authentication control apparatus according to claim 1, wherein
pressure sensors corresponding to the plurality of light emitting elements, respectively, are further embedded in the passage, and
wherein the at least one processor is further configured to execute the instructions to:
acquire a detection result from the pressure sensor, and
specify the position further in consideration of the detection result.

16. The authentication control apparatus according to claim 1,
wherein the at least one processor is further configured to execute the instructions to:
output a predetermined warning for the specified position to a speaker with high directivity installed in the passage in a case where the biometric authentication result indicates that the authentication has failed.

17. The authentication control apparatus according to claim 1,
wherein the at least one processor is further configured to execute the instructions to:
detect the number of persons in the passage from the captured image;
calculate a remaining number of passable persons from a maximum number of passable persons of the passage and the detected number of persons,
perform display control in such a way as to cause a predetermined light emitting element to display the calculated number of passable persons, and
perform display control in such a way as to cause the predetermined light emitting element to display a warning in a case where the detected number of persons exceeds the maximum number of passable persons.

18. The authentication control apparatus according to claim 1, further comprising
the at least one processor is further configured to execute the instructions to:
transmit the captured image and the biometric authentication result to a predetermined information processing apparatus via a network in a case where the biometric authentication result indicates that the authentication has failed.

19. The authentication control apparatus according to claim 1,
wherein the at least one processor is further configured to execute the instructions to:
cause an authentication apparatus that stores the biometric information of the plurality of persons to perform the authentication using the biometric information acquired from the captured image, and acquire the biometric authentication result from the authentication apparatus.

20. The authentication control apparatus according to claim 1, further comprising storage, device configured to store the biometric information of the plurality of persons,
wherein the at least one processor is further configured to execute the instructions to:
acquire the biometric authentication result by performing the authentication by collating the biometric information of the plurality of persons with the biometric information acquired from the captured image.

21. An authentication control system comprising:
a plurality of light emitting elements embedded in a predetermined passage;
an imaging device; and
an authentication control apparatus connected to the plurality of light emitting elements and the imaging device,
wherein the authentication control apparatus includes:
at least one storage device configured to store instructions; and
at least one processor configured to execute the instructions to:
acquire biometric information of a pedestrian on the passage from a captured image of the pedestrian captured by the imaging device;
acquire a biometric authentication result obtained using the acquired biometric information and biometric information of a plurality of persons;
specify a position of the pedestrian on the passage by analyzing the captured image; and
perform display control related to the biometric authentication result for the light emitting element corresponding to a light emission target region including the specified position.

22. The authentication control system according to claim 21, wherein the at least one processor is further configured to execute the instructions to:
decide a display mode and the light emission target region based on the biometric authentication result, and
perform display control according to the decided display mode for the light emitting element corresponding to the decided light emission target region.

23. An authentication control method performed by a computer, the authentication control method comprising:
acquiring biometric information of a pedestrian on a predetermined passage in which a plurality of light emitting elements are embedded from a captured image of the pedestrian;
acquiring a biometric authentication result obtained using the acquired biometric information and biometric information of a plurality of persons;
specifying a position of the pedestrian on the passage by analyzing the captured image; and
performing display control related to the biometric authentication result for the light emitting element corresponding to a light emission target region including the specified position.

24. A non-transitory computer-readable medium storing an authentication control program that causes a computer to perform:
biometric information acquisition processing of acquiring biometric information of a pedestrian on a predetermined passage in which a plurality of light emitting elements are embedded from a captured image of the pedestrian;
authentication control processing of acquiring a biometric authentication result obtained using the acquired biometric information and biometric information of a plurality of persons;
position specifying processing of specifying a position of the pedestrian on the passage by analyzing the captured image; and
display control processing of performing display control related to the biometric authentication result for the light emitting element corresponding to a light emission target region including the specified position.
